(19) United States
(12) Patent Application Publication
(10) Pub. No.: US 2016/0032126 A1
(43) Pub. Date: Feb. 4, 2016

(54) CONDUCTIVE INK COMPOSITION, CONDUCTOR, AND ELECTRONIC DEVICE

(71) Applicant: SAMSUNG ELECTRONICS CO., LTD., Suwon-si (KR)

(72) Inventors: Seonmi YOON, Hwaseong-si (KR); Sunghoon PARK, Seoul (KR); Youngseon SHIM, Yongin-si (KR)

(21) Appl. No.: 14/595,353

(22) Filed: Jan. 13, 2015

(30) Foreign Application Priority Data
Jul. 29, 2014 (KR) 10-2014-0096610

(51) Int. Cl. C09D 11/52; H01B 1/22

(52) U.S. Cl. CPC C09D 11/52; H01B 1/22

(57) ABSTRACT

A conductive ink composition including: a metal nanostructure, a binder, and a solvent including water and an alcohol, wherein the alcohol is included in an amount of less than about 40 weight percent, based on a total weight of the water and the alcohol.

This application claims priority to and the benefit of Korean Patent Application No. 10-2014-0096610, filed in the Korean Intellectual Property Office on Jul. 29, 2014, and all the benefits accruing therefrom under 35 U.S.C. §119, the entire content of which is incorporated herein by reference.

### BACKGROUND

1. Field

A conductive ink composition, a conductor, and an electronic device are disclosed.

2. Description of the Related Art

An electronic device such as a liquid crystal display (LCD), an organic light emitting diode device, and a touch panel screen includes a transparent conductor as a transparent electrode.

The transparent conductor may be classified according to the material. For example, the transparent conductor may include an organic material-based transparent conductor such as a conductive polymer, an oxide-based transparent conductor such as indium tin oxide (ITO), and a metal-based transparent conductor such as a metal grid.

However, the conductive polymer has high resistivity and low transparency, and may be easily degraded when exposed to moisture and air. The indium tin oxide (ITO) may increase the manufacture cost by using an expensive main element of indium, and may have a limit to be applied for a flexible device due to low flexibility. The metal-based transparent conductor may increase the manufacture cost since the manufacturing process is complicated.

On the other hand, as the flexible device has drawn more attention, the material for a transparent electrode of the flexible device has been researched, and for example, may include a metal nanostructure ink composition. However, the metal nanostructure ink composition has a large amount of organic residues and may deteriorate film-forming characteristics.

### SUMMARY

An embodiment provides a conductive ink composition that provides decreased organic residues and improved film-forming characteristics.

Another embodiment provides a conductor including the conductive ink composition.

Yet another embodiment provides an electronic device including the conductor as an electrode.

According to an embodiment, a conductive ink composition includes: a metal nanostructure; a binder; and a solvent including water and an alcohol, wherein the alcohol is included in an amount of less than about 40 weight percent (wt %), based on a total weight of the water and the alcohol.

The alcohol may be included in an amount of about 5 to about 38 wt %, based on the total weight of the water and the alcohol, and the water may be included in an amount of about 62 to about 95 wt %, based on the total weight of the water and the alcohol.

The alcohol may include methanol, ethanol, n-propyl alcohol, isopropyl alcohol, n-butanol, isobutanol, t-butanol, propylene glycol, propylene glycol methyl ether, ethylene glycol, or a combination thereof.

The conductive ink composition may have a contact angle of about 30 to about 71 degrees on a substrate.

The metal nanostructure may be included in an amount of about 0.04 to about 0.2 wt %, based on the total weight of the conductive ink composition, the binder may be included in an amount of about 5 to about 50 parts by weight, based on 100 parts by weight of the metal nanostructure, and the solvent may be included in a balance amount.

The conductive ink composition may further include a polymeric dispersing agent.

The polymeric dispersing agent may have a weight average molecular weight of about 40,000 Daltons or less.

The polymeric dispersing agent may include a (meth)acrylate compound.

The metal nanostructure may be included in an amount of about 0.04 to about 0.2 wt %, based on the total weight of the ink composition, the binder may be included in an amount of about 5 to about 50 parts by weight, based on 100 parts by weight of the metal nanostructure, the polymeric dispersing agent may be included in an amount of about 0.1 to about 5 parts by weight, based on 100 parts by weight of the metal nanostructure, and the solvent may be included in a balance amount.

The metal nanostructure may include a polymer-coated silver nanostructure.

The metal nanostructure may include a polyvinylpyrrolidone-coated silver nanostructure.

According to another embodiment, a method of manufacturing a conductor includes: preparing a conductive ink composition including a metal nanostructure, a binder, and a solvent including water and an alcohol, wherein the alcohol is included in an amount of less than about 40 weight percent, based on a total weight of the water and the alcohol; applying the conductive ink composition; and drying the conductive ink composition to manufacture the conductor.

The applying of the conductive ink composition may be performed by bar coating, blade coating, slot die coating, or a combination thereof.

The conductive ink composition may further include a polymeric dispersing agent.

The polymeric dispersing agent may include a (meth)acrylate compound having a weight average molecular weight of about 40,000 or less.

According to another embodiment, a conductor formed from the conductive ink composition is provided.

The conductor may simultaneously have a haze of about 1.10% or less and light transmittance of about 85% or more.

According to yet another embodiment, a conductor includes a metal nanostructure simultaneously having a haze of about 1.10% or less and light transmittance of about 85% or more.

According to still another embodiment, an electronic device including the conductor is provided.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a schematic cross-sectional view of an embodiment of an organic light emitting diode device;

FIG. 2 is a scanning electron microscope (SEM) photograph of the transparent conductive film formed from the composition of Example 1;

FIG. 3 is a scanning electron microscope (SEM) photograph of the transparent conductive film formed from the composition of Comparative Example 1;

FIG. 4 is a scanning electron microscope (SEM) photograph of the transparent conductive film formed from the composition of Comparative Example 2; and

FIG. 5 is a scanning electron microscope (SEM) photograph of the transparent conductive film formed from the composition of Comparative Example 3.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, a conductive ink composition according to an embodiment is further disclosed.

A conductive ink composition according to an embodiment includes a metal nanostructure, a binder, and a solvent.

The metal nanostructure is a nano-sized structure including a metal, and may comprise, for example, a nanowire, a nanotube, a nanoparticle, a nanocapsule, a nanosphere, or a combination thereof, and may have a diameter of several nanometers (nm) to several hundreds of nanometers. The metal nanostructure may have a diameter of, for example, less than or equal to about 500 nm, for example, about 10 nm to about 500 nm, or for example, of about 20 nm to about 300 nm.

The metal nanostructure may include, for example, a low resistance metal such as silver (Ag) or copper (Cu), and for example, may comprise a silver nanostructure. The metal nanostructure may include a metal-comprising nanostructure coated with an organic material, an inorganic material, or an organic/inorganic material on a surface thereof, as well as a metal-comprising nanostructure. The organic material, the inorganic material, or the organic/inorganic material coated on the surface of the metal-comprising nanostructure may prevent the metal nanostructure from agglomerating together thereby enhancing the dispersibility of the metal nanostructure.

For example, the metal nanostructure may comprise a polymer-coated metal nanostructure, and for another example, a polyvinylpyrrolidone (PVP)-coated metal nanostructure. For example, the metal nanostructure may comprise a polymer-coated silver nanostructure, and for another example a polyvinylpyrrolidone-coated silver nanostructure.

The metal nanostructure may be included in an amount of about 0.04 to about 0.2 wt %, based on the total weight of the ink composition. By including the metal nanostructure within the range, the light transmittance may be ensured while having sufficient conductivity.

The binder is not particularly limited as long as a suitable viscosity of the conductive ink composition may be provided, and a suitable binding force of the metal nanostructure to the substrate is provided. The binder may be, for example, an organic binder, for another example methylcellulose, ethylcellulose, hydroxypropyl methylcellulose (HPMC), hydroxypropyl cellulose (HPC), xanthan gum, polyvinyl alcohol (PVA), polyvinyl pyrrolidone (PVP), carboxymethyl cellulose, hydroxylethyl cellulose, or a combination thereof, but is not limited thereto.

The binder may be included in an amount of about 5 to about 50 parts by weight, based on 100 parts by weight of the metal nanostructure.

The solvent may include a medium which is capable of dissolving and/or dispersing the metal nanostructure and the binder.

The solvent includes water and an alcohol. The water may be a primary solvent of the conductive ink composition and a hydrophilic polar solvent, and may well disperse the metal nanostructure. The alcohol may be a secondary solvent of the conductive ink composition, and may be included at less than about 40 wt %, based on the total amount of the water and alcohol.

By including the alcohol within the foregoing range, the surface characteristics of the conductive ink composition may be selected to appropriately control the wettability to the substrate, while the dispersion of the metal nanostructure is not deteriorated. In addition, decreased foam generation when coating the conductive ink composition may be provided to improve the film-forming characteristics.

For example, the alcohol may be included in an amount of about 5 to about 38 wt %, based on the total weight of the water and the alcohol, and the water may be included in an amount of about 62 to about 95 wt %, based on the total amount of the water and alcohol. Within the ranges, for example, the alcohol may be included in an amount of about 10 to about 30 wt %, based on the total weight of the water and the alcohol, and the water about may be included in an amount of about 70 to about 90 wt %, based on the total weight of the water and the alcohol.

The conductive ink composition may have a contact angle of about 30 to about 71 degrees, and the contact angle may be measured to the substrate by a contact angle measuring instrument, for example, a DSA 10 Mk2 (Kruss) instrument. In an embodiment, the contact angle may be determined on a substrate, e.g., polyethylene terephthalate (PET). In another embodiment, the contact angle may be determined on a substrate, e.g., polycarbonates (PC).

By having the contract angle within the foregoing range, an appropriate wettability to the substrate may be provided, so as to provide the appropriate affinity to the substrate and to maintain adherence with the substrate while decreasing the binder content. Thus, prevention of a large amount of organic residue of the binder remaining in the conductor formed from the conductive ink composition may be prevented, thereby decreasing haze. Within the range, the contact angle may range, for example, from about 30 degrees to about 60 degrees, or for example, from about 30 degrees to about 50 degrees. In an embodiment, the contact angle may be determined on a substrate, e.g., polyethylene terephthalate (PET) and is about 30 degrees to about 60 degrees, or for example, from about 30 degrees to about 50 degrees. In another embodiment, the contact angle may be determined on a substrate, e.g., polycarbonates (PC), and is about 30 degrees to about 60 degrees, or for example, from about 30 degrees to about 50 degrees.

The alcohol may be, for example, methanol, ethanol, n-propyl alcohol, isopropyl alcohol, n-butanol, isobutanol, t-butanol, propylene glycol, propylene glycol methyl ether, ethylene glycol, or a combination thereof.

The conductive ink composition may further include a polymeric dispersing agent. The polymeric dispersing agent may be a polymer having a weight average molecular weight of about 40,000 Daltons (Da) or less, and may include, for example, a (meth)acrylate compound. By using a polymer having the weight average molecular weight within the foregoing range, the sheet resistance and haze increase caused by the polymeric dispersing agent may be prevented.

The polymeric dispersing agent may be included in an amount of about 0.1 to about 5 parts by weight, based on 100 parts by weight of the metal nanostructure.

The conductive ink composition is applied on the substrate and dried to provide a conductor.

The substrate may be a glass substrate, a semiconductor substrate, or a polymer substrate, and may include a substrate stacked with an insulation layer and/or a conductive layer. The conductive ink composition may be applied on the substrate according to any suitable method, for example, bar coating, blade coating, slot die coating, or a combination thereof.

The drying may be performed by natural drying, hot-air drying, or heat-treating at a temperature of greater than or equal to the boiling point of the solvent.

The conductive ink composition has improved wettability to the substrate and improved dispersibility of the metal nanostructure as described above, so as to provide improved film-forming characteristics regardless of the kind of substrate and the coating method. In addition, by including a selected amount of auxiliary solvent as described above, the binder content may be relatively reduced to decrease the haze which may occur when a large amount of the organic residue is present.

The conductor may have reduced organic residue remaining in the conductor as discussed above, and for example, the organic residue remaining in the conductor may range from about 5 to 50 parts by weight, based on 100 parts by weight of the metal nanostructure, or for example, from about 5.5 to 43 parts by weight, based on 100 parts by weight of the metal nanostructure.

The conductor may be, for example, a transparent electrode, and may simultaneously have a haze of about 1.10% or less and light transmittance of about 85% or more. Within these ranges, the haze may be, for example, about 0.50 to about 1.10%, and for another example about 0.70 to about 1.10%. Within these ranges, the light transmittance may be, for example, about 85 to about 100%, and for another example about 90 to about 100%. By providing both haze and light transmittance within the ranges, the conductor may be used to provide a transparent electrode.

The conductor may have sheet resistance of less than about 100 ohms per square (Ω/sq). Within this range, it may have sheet resistance of about 20 to about 90 Ω/sq., or about 50 to about 90 Ω/sq. By having the foregoing sheet resistance, the conductor may be used to provide a low resistance transparent electrode.

The conductor may be applied as a transparent electrode of various electronic devices. The electronic devices may be, for example, a flat panel display such as a liquid crystal display (LCD), or an organic light emitting device, a touch panel screen, a solar cell, an e-window, a heat mirror, or a transparent transistor, but are not limited thereto. In addition, the conductor may be in the form of a thin film including the metal nanostructure and thus may be used to provide a flexible electronic device having sufficient flexibility.

Hereinafter, as an example of the electronic device, an organic light emitting diode device including the conductor as a transparent electrode is further described referring to drawings.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

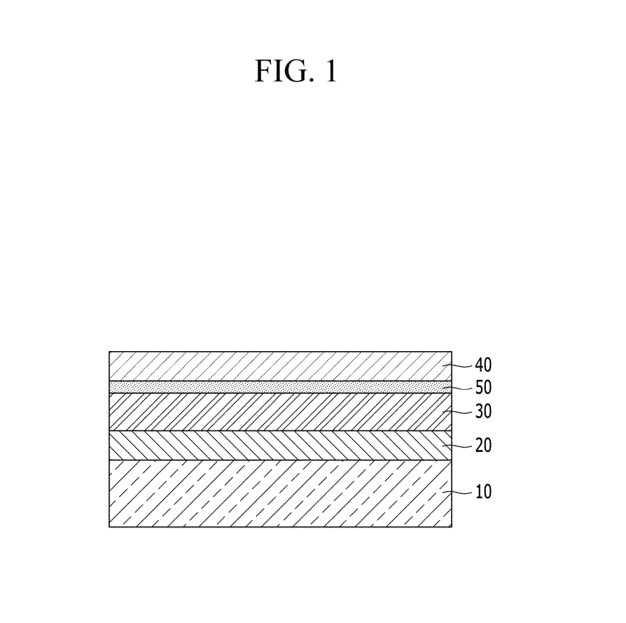

FIG. 1 is a schematic cross-sectional view of an embodiment of an organic light emitting diode device.

Referring to FIG. 1, the organic light emitting diode device according to an embodiment includes a substrate 10, a lower electrode 20, an upper electrode 40 facing the lower electrode 20, and an emission layer 30 interposed between the lower electrode 20 and the upper electrode 40.

The substrate 10 may include, for example, an inorganic material such as glass, or an organic material such as polycarbonate, polymethylmethacrylate, polyethylene terephthalate, polyethylene naphthalate, polyamide, polyethersulfone, or a combination thereof, or a silicon wafer.

One of the lower electrode 20 and the upper electrode 40 is a cathode, and the other is an anode. For example, the lower electrode 20 may be an anode and the upper electrode 40 may be a cathode.

At least either one of the lower electrode 20 and the upper electrode 40 is transparent. When the lower electrode 10 is transparent, an organic light emitting diode device may have bottom emission in which light is emitted toward the substrate 10, while when the upper electrode 40 is transparent, the organic light emitting diode device may have top emission in which a light is emitted away from the substrate 10. In addition, when the lower electrode 20 and upper electrode 40 are both transparent, light may be emitted toward the substrate 10 and away from the substrate 10 in both sides.

The transparent electrode comprises a product of the conductive ink composition. The conductive ink composition is the same as is further disclosed above.

The emission layer 30 may comprise an organic material emitting light of one of the primary colors such as red, green, and blue, or a mixture of an inorganic material with the organic material, for example, a polyfluorene derivative, a (poly)paraphenylene vinylene derivative, a polyphenylene derivative, a polyfluorene derivative, polyvinylcarbazole, a polythiophene derivative, or a compound prepared by doping these polymer materials with a perylene-based pigment, a coumarin-based pigment, a rothermine-based pigment, rubrene, perylene, 9,10-diphenylanthracene, tetraphenyl butadiene, Nile red, coumarin, quinacridone, and the like. An organic light emitting diode device displays a desirable image by a spatial combination of primary colors emitted by an emission layer therein.

The emission layer 30 may emit white light by combining three primary colors such as red, green, and blue. Specifically, the emission layer 30 may emit white light by combining colors of neighboring sub-pixels or by combining laminated colors in a vertical direction.

An auxiliary layer 50 may be positioned between the emission layer 30 and the upper electrode 40 to improve luminous efficiency. In the drawing, the auxiliary layer 50 is shown only between the emission layer 30 and the upper electrode 40, but is not limited thereto, and may be positioned between and emission layer 30 and the lower electrode 20, between the emission layer 30 and the upper electrode 40, and between the emission layer 30 and the lower electrode 20.

The auxiliary layer 50 may include an electron transport layer (ETL) and a hole transport layer (HTL) for balancing between electrons and holes, an electron injection layer (EIL), a hole injection layer (HIL) for reinforcing injection of electrons and holes, and the like. It may include one or more layers selected therefrom. The auxiliary layer 50 may be omitted.

Herein, the organic light emitting diode device including the transparent electrode made of the conductive ink composition is further disclosed. But the embodiments are not limited thereto, and may be applied to any electronic device including a transparent electrode. For example, they may be applied to a pixel electrode and/or a common electrode of a liquid crystal display (LCD), a display electrode of a plasma display device, or a transparent electrode of a touch panel device.

Hereinafter, the embodiments are illustrated in more detail with reference to examples. These examples, however, are not in any sense to be interpreted as limiting the scope of this disclosure.

### EXAMPLES

### Preparation of Composition

### Example 1

A composition is prepared by including 0.384 grams (g) of an aqueous solution including a silver nanostructure coated with 1.3 wt % of polyvinyl pyrrolidone (PVP), 0.5 g of an aqueous solution including 0.25 wt % of hydroxypropyl methylcellulose (HPMC) (H7509, manufactured by Sigma), water, and isopropyl alcohol. The weight ratio of total water content and the isopropyl alcohol content included in the composition is 79.2:21.8.

### Example 2

A composition is prepared by including 2 g of an aqueous solution including a silver nanostructure coated with 0.5 wt % of polyvinyl pyrrolidone (PVP), 0.5 g of an aqueous solution including 0.25 wt % of hydroxypropyl methylcellulose (HPMC), 1 g of aqueous solution including 0.025 wt % of polyacrylate (DISPERBYK2012), water, and ethanol. The weight ratio of total water content and the ethanol content included in the composition is 75:25.

### Example 3

A composition is prepared by including 0.384 g of an aqueous solution including a silver nanostructure coated with 1.3 wt % of polyvinyl pyrrolidone (PVP), 0.5 g of an aqueous solution including 0.25 wt % of hydroxypropyl methylcellulose (HPMC), 1 g of an aqueous solution including 0.025 wt % of dispersing agent (BYK190), water, and ethanol. The weight ratio of total water content and the ethanol content included in the composition is 75:25.

### Example 4

A composition is prepared by including 0.384 g of an aqueous solution including a silver nanostructure coated with 1.3 wt % of polyvinyl pyrrolidone (PVP), 0.5 g of aqueous solution including 0.25 wt % of hydroxypropyl methylcellulose (HPMC), 1 g of an aqueous solution including 0.025 wt % of poly(acrylic acid-co-maleic acid-Na) (molecular weight: about 3000), water, and ethanol. The weight ratio of total water content and the ethanol content included in the composition is 75:25.

### Example 5

A composition is prepared by including 0.384 g of an aqueous solution including a silver nanostructure coated with 1.3 wt % of polyvinyl pyrrolidone (PVP), 0.5 g of an aqueous solution including 0.25 wt % of hydroxypropyl methylcellulose (HPMC), 1 g of an aqueous solution including 0.025 wt % of polyacrylate-Na (molecular weight: about 1800), water, and ethanol. The weight ratio of total water content and the ethanol content included in the composition is 75:25.

### Comparative Example 1

A composition is prepared in accordance with the same procedure as in Example 1, except that the isopropyl alcohol is not included.

### Comparative Example 2

A composition is prepared in accordance with the same procedure as in Example 1, except that the weight ratio of the total water content and the isopropyl alcohol content included in the composition is 56:44.

### Comparative Example 3

A composition is prepared in accordance with the same procedure as in Example 1, except that the weight ratio of the total water content and the isopropyl alcohol content included in the composition is 29.8:70.2.

### Evaluation

### Evaluation 1

The compositions prepared from Examples 1 to 5 and Comparative Examples 1 to 3 are evaluated for a contact angle.

The contact angle is measured on Polyethylene terephthalate (PET) substrate by DSA 10 Mk2 (Kruss) equipment after dripping the composition.

The results are shown in Table 1.

TABLE 1

| | Contact angle |
|---|---|
| | (degrees) |
| Example 1 | 35.1 |
| Example 2 | 50.2 |
| Example 3 | 51.2 |
| Example 4 | 49.3 |
| Example 5 | 48.7 |
| Comparative Example 1 | 76.7 |
| Comparative Example 2 | 11 |
| Comparative Example 3 | 8 |

### Evaluation 2

The compositions according to Examples 1 to 5 and Comparative Examples 1 to 3 are coated on a PET substrate at a rate of 30 millimeters per second (mm/s) in an area of 20*80 square centimeters (cm²) using a bar coater, and hot air dried at 85° C. for 2 minutes to provide a transparent conductive layer.

The film-forming properties of the transparent conductive layer are evaluated. The film-forming properties are evaluated from coating uniformity determining whether foam is generated or not and how the silver nanostructure is agglomerated according to the dispersibility of the silver nanostructure.

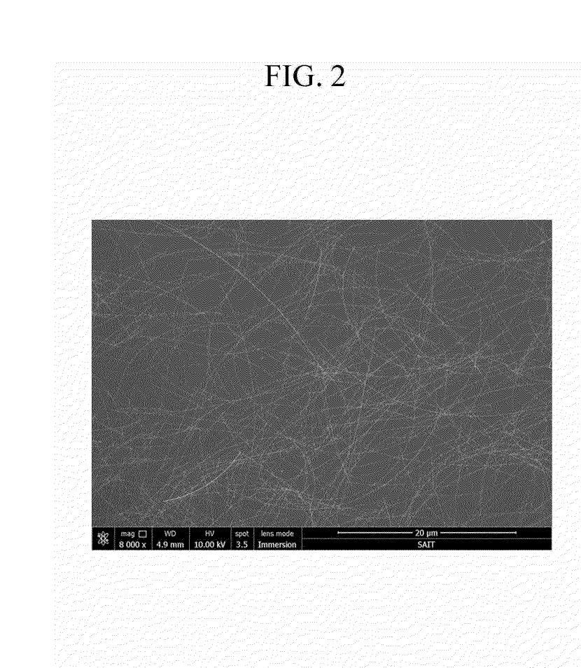

The results are shown in Table 2 and FIG. 2 to FIG. 5.

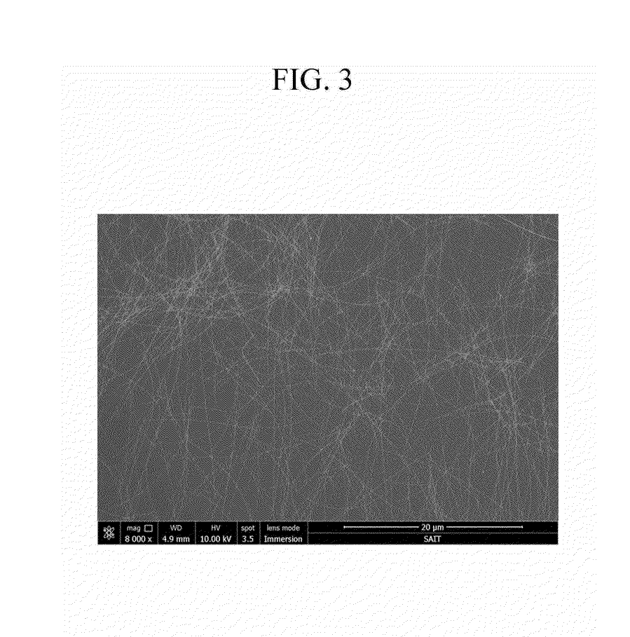

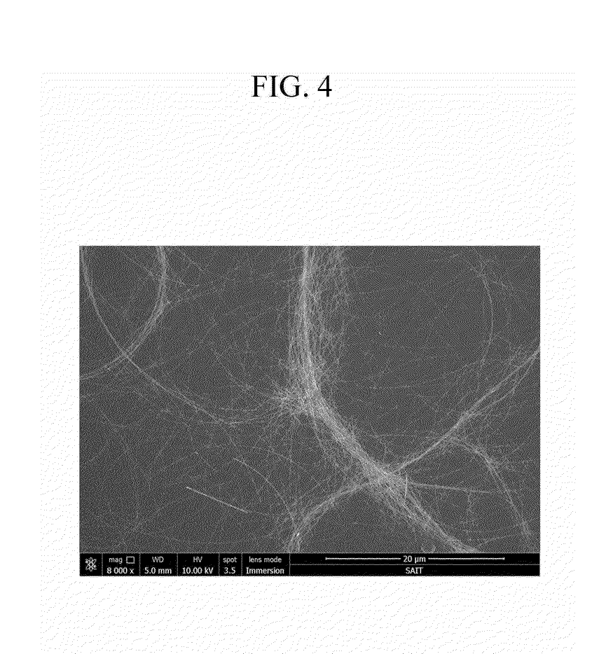

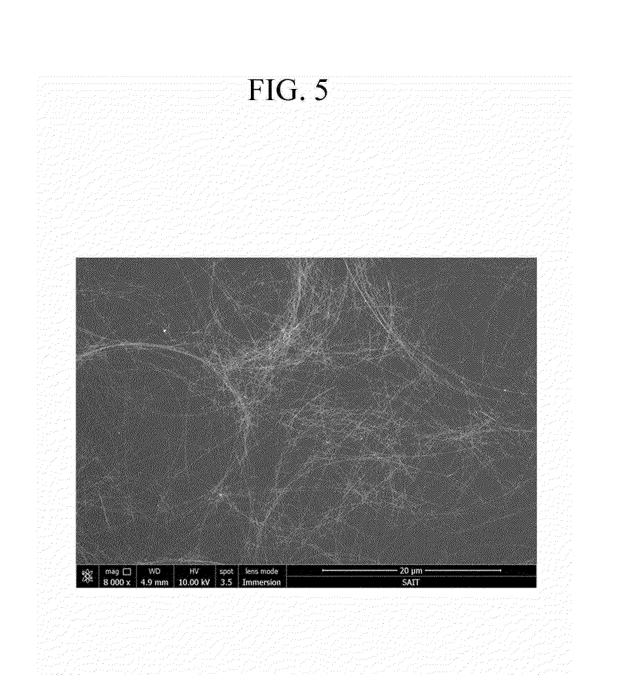

FIG. 2 is a scanning electron microscope (SEM) photograph of the transparent conductive film formed from the composition of Example 1, FIG. 3 is a scanning electron microscope (SEM) photograph of the transparent conductive film formed from the composition of Comparative Example 1, FIG. 4 is a scanning electron microscope (SEM) photograph of the transparent conductive film formed from the composition of Comparative Example 2, and FIG. 5 is a scanning electron microscope (SEM) photograph of the transparent conductive film formed from the composition of Comparative Example 3.

TABLE 2

| | | Agglomeration of silver |
|---|---|---|
| | Foam generation | nanostructure |
| Example 1 | X | X |
| Example 2 | X | X |
| Example 3 | X | X |
| Example 4 | X | X |
| Example 5 | X | X |
| Comparative Example 1 | ⊚ | X |
| Comparative Example 2 | X | ⊚ |
| Comparative Example 3 | X | ⊚ |

X: foam is not observed/agglomeration of silver nanostructure is not observed
⊚: foam is observed/agglomeration of silver nanostructure is observed

Referring to Table 2 and FIG. 2 to FIG. 5, the compositions according to Examples 1 to 5 have no foam during the coating process to provide good coating uniformity and excellent dispersibility of the silver nanostructure, so it is confirmed that the silver nanostructure is little agglomerated.

### Evaluation 3

The compositions according to Examples 1 to 5 and Comparative Examples 1 to 3 are coated on the PET substrate using a bar coater at a rate of 30 mm/s in an area of 20*80 cm² and then hot-air dried at 85° C. for 2 minutes to provide a transparent conductive film.

The transparent conductive film is evaluated for sheet resistance, light transmittance, and haze.

The sheet resistance is measured using a four-point measurer (RCHCK, EDTM) 18 times and averaged, and the light transmittance and haze are measured using NDH7000SP (NDK) equipment 6 times and averaged.

The results are shown in Table 3.

TABLE 3

| | Sheet resistance | Light transmittance | Haze |
|---|---|---|---|
| | (Ω/sq.) | (%) | (%) |
| Example 1 | 61.3 | 89.2 | 0.91 |
| Example 2 | 45.0 | 88.8 | 1.03 |
| Example 3 | 44.3 | 88.6 | 0.90 |
| Example 4 | 44.1 | 88.7 | 0.82 |
| Example 5 | 45.4 | 88.7 | 0.76 |
| Comparative | 40.7 | 88.5 | 1.5 |
| Example 1 | | | |
| Comparative | 74.3 | 88.1 | 1.55 |
| Example 2 | | | |
| Comparative | 83.7 | 88.7 | 1.18 |
| Example 3 | | | |

Referring to Table 3, it is confirmed that the transparent conductive films formed by the compositions according to Examples 1 to 5 provide light transmittance of about 85% and haze of less than or equal to about 1.10%.

While this disclosure has been described in connection with what is presently considered to be practical exemplary embodiments, it is to be understood that the invention is not limited to the disclosed embodiments, but, on the contrary, is intended to include various modifications and equivalent arrangements included within the spirit and scope of the appended claims.

What is claimed is:

1. A conductive ink composition comprising:
a metal nanostructure;
a binder; and
a solvent comprising water and an alcohol,
wherein the alcohol is included in an amount of less than about 40 weight percent, based on a total weight of the water and the alcohol.

2. The conductive ink composition of claim 1, wherein the alcohol is included in an amount of about 5 to about 38 weight percent, based on a total weight of the water and the alcohol, and
the water is included in an amount of about 62 to about 95 weight percent, based on a total weight of the water and the alcohol.

3. The conductive ink composition of claim 1, wherein the alcohol comprises methanol, ethanol, n-propyl alcohol, isopropyl alcohol, n-butanol, isobutanol, t-butanol, propylene glycol, propylene glycol methyl ether, ethylene glycol, or a combination thereof.

4. The conductive ink composition of claim 1, wherein the conductive ink composition has a contact angle of about 30 to about 71 degrees on a substrate.

5. The conductive ink composition of claim 1, wherein the metal nanostructure is included in an amount of about 0.04 to about 0.2 weight percent, based on a total weight of the conductive ink composition,
the binder is included in an amount of about 5 to about 50 parts by weight, based on 100 parts by weight of the metal nanostructure, and
the solvent is included in a balance amount.

6. The conductive ink composition of claim 1, further comprising a polymeric dispersing agent.

7. The conductive ink composition of claim 6, wherein the polymeric dispersing agent has a weight average molecular weight of about 40,000 Daltons or less.

8. The conductive ink composition of claim 6, wherein the polymeric dispersing agent comprises a (meth)acrylate compound.

9. The conductive ink composition of claim 6, wherein the metal nanostructure is included in an amount of about 0.04 to about 0.2 weight percent, based on a total weight of the ink composition,
the binder is included in an amount of about 5 to about 50 parts by weight, based on 100 parts by weight of the metal nanostructure,
the polymeric dispersing agent is included in an amount of about 0.1 to about 5 parts by weight, based on 100 parts by weight of the metal nanostructure, and
the solvent is included in a balance amount.

10. The conductive ink composition of claim 1, wherein the metal nanostructure comprises a polymer-coated silver nanostructure.

11. The conductive ink composition of claim 10, wherein the metal nanostructure comprises a polyvinylpyrrolidone-coated silver nanostructure.

12. A method of manufacturing a conductor, comprising:
preparing a conductive ink composition including a metal nanostructure, a binder, and a solvent including water and an alcohol, wherein the alcohol is included in an amount of less than about 40 weight percent, based on a total weight of the water and the alcohol;
applying the conductive ink composition; and
drying the conductive ink composition to manufacture the conductor.

13. The method of claim 12, wherein the applying the conductive ink composition comprises bar coating, blade coating, slot die coating, or a combination thereof.

14. The method of claim 12, wherein the conductive ink composition further comprises a polymeric dispersing agent.

15. The method of claim 14, wherein the polymeric dispersing agent includes a (meth)acrylate compound having a weight average molecular weight of about 40,000 Daltons or less.

16. A conductor comprising a product of the conductive ink composition of claim 1.

17. The conductor of claim 16, wherein the conductor simultaneously has a haze of about 1.10% or less and light transmittance of about 85% or more.

18. An electronic device comprising the conductor of claim 16.

19. A conductor comprising a metal nanostructure and simultaneously having a haze of about 1.10% or less and light transmittance of about 85% or more.

20. An electronic device comprising the conductor of claim 19.
